(19) United States
(12) Patent Application Publication
(10) Pub. No.: US 2015/0211882 A1
(43) Pub. Date: Jul. 30, 2015

(54) SYSTEMS AND METHODS FOR PROVIDING INTERVAL-BASED POINT OF INTEREST INFORMATION

(71) Applicant: GM GLOBAL TECHNOLOGY OPERATIONS LLC, DETROIT, MI (US)

(72) Inventors: DAVID B. GUMPERT, FARMINGTON HILLS, MI (US); JOSEPH P. KELLY, PINCKNEY, MI (US)

(73) Assignee: GM GLOBAL TECHNOLOGY OPERATIONS LLC, DETROIT, MI (US)

(21) Appl. No.: 14/166,391

(22) Filed: Jan. 28, 2014

(51) Int. Cl. G01C 21/36

(52) U.S. Cl. CPC G01C 21/3679

(57) ABSTRACT

A method provides point of interest information in a vehicle along a route to a destination. The method includes receiving, from a user, an interval between a current location and the destination; determining an interval location based on the interval; generating point of interest information associated with the interval location; and displaying the point of interest information on a display device.

### TECHNICAL FIELD

The technical field generally relates to vehicle systems and methods and more particularly relates to vehicle systems and methods that generate point of interest information based on a user-defined interval along a travel route.

### BACKGROUND

Mobile, in-vehicle information systems, such as navigation systems, have become commonplace in vehicles such as automobiles, trucks, sport utility vehicles, etc. The navigation systems typically use a GPS navigation device to locate the vehicle and to display a map of the vehicle location on a display screen. Some systems additionally provide directions for the user based on an intended destination. Depending on the system, the user may also interact with the navigation system to update the vehicle position and/or intended destination, typically by entering data on a touch screen or keyboard associated with the display screen.

Some conventional information systems may attempt to provide point of interest information. The points of interest may include commercial establishments, such as hotels, restaurants, or tourist attractions. For example, the system may provide information about restaurants proximate to a current location along the route. Despite these advances, point of interest information may be desirable in additional scenarios.

Accordingly, it is desirable to provide vehicle systems and methods for providing improved point of interest information. Furthermore, other desirable features and characteristics will become apparent from the subsequent detailed description and the appended claims, taken in conjunction with the accompanying drawings and the foregoing technical field and background.

### SUMMARY

In accordance with an exemplary embodiment, a method provides point of interest information in a vehicle along a route to a destination. The method includes receiving, from a user, an interval between a current location and the destination; determining an interval location based on the interval; generating point of interest information associated with the interval location; and displaying the point of interest information on a display device.

In accordance with an exemplary embodiment, a system provides point of interest information in a vehicle along a route to a destination. The system includes a point of interest data source storing point of interest information for a plurality of points of interest; a control module coupled to the point of interest data source and configured to receive, from a user, an interval between a current location and the destination; determine an interval location based on the interval; and retrieve point of interest information associated with the interval location from the point of interest data source; and a display device coupled to the control module and configured to display the point of interest information associated with the interval location.

### DESCRIPTION OF THE DRAWINGS

One or more examples will hereinafter be described in conjunction with the following drawing figures, wherein like numerals denote like elements, and wherein:

FIG. 1 is a simplified schematic representation of an information system in accordance with an exemplary embodiment;

FIG. 2 is a flowchart of an exemplary method for generating point of interest information in accordance with an exemplary embodiment;

FIGS. 3-10 are exemplary representations of displays produced by the system of FIG. 1 and method of FIG. 2 in accordance with exemplary embodiments; and

FIG. 11 is a simplified schematic representation of an information system in accordance with an alternate exemplary embodiment.

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description.

Broadly, exemplary embodiments discussed herein provide information systems and methods that provide point of interest information based on user-defined intervals. For example, the interval may be defined as a distance or time from a current location or from a future location.

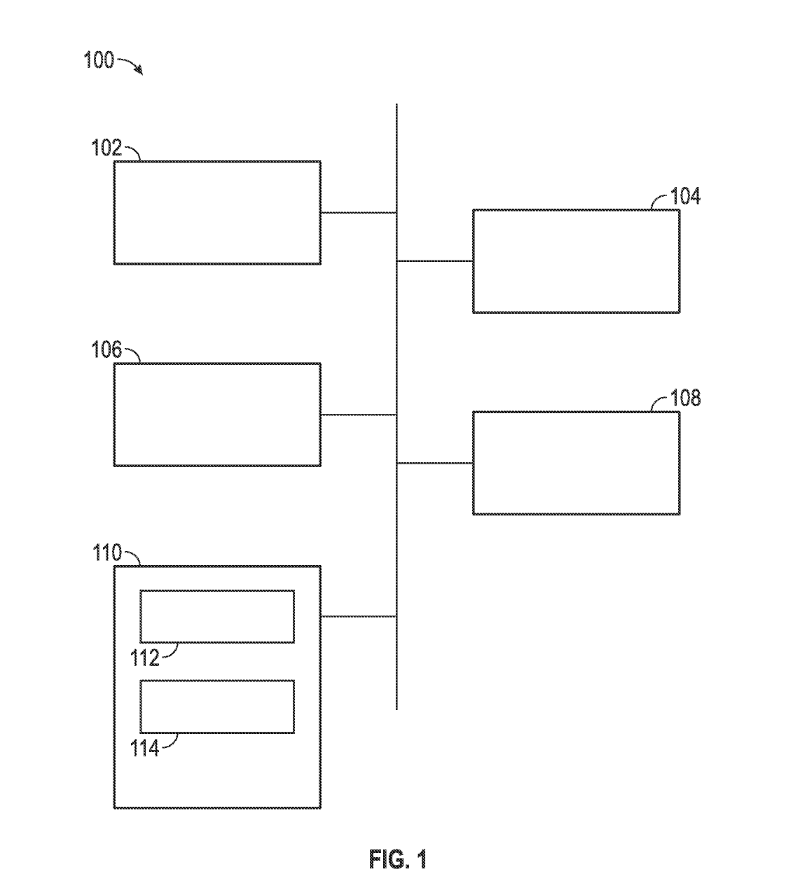

FIG. 1 is a schematic representation of an information system 100 in accordance with an exemplary embodiment. As discussed in greater detail below, the information system 100 may be embodied as a vehicle system or a general purpose computer. In some embodiments, the information system 100 may be implemented with a personal electronic device (e.g., a smart phone or cell phone). The information system 100 may also be referred to as a route planning system or mapping system.

The information system 100 generally includes a control module 102 coupled to a navigation module 104, at least one point of interest data source 106, an audio device 108, and a graphical user interface 110, which generally includes a display device 112 and a user input device 114. In practice, the components of the information system 100 may be coupled together in a manner that facilitates the communication of data, instructions, control signals, and other signals to and from the control module 102. Of course, additional components configured to perform additional functions may be provided.

Generally, the control module 102 is configured as the processing module of the information system 100, that executes stored control logic to perform or otherwise support the various operations and functions described herein. For example, the control module 102 may include any type of computer, microprocessor or controller, as well as any additional logical or functional elements realized by hardware, software, firmware, or any combination thereof, such as additional processors, controllers, memory elements, or the like. As described in greater detail below, the control module 102 may include a wired or wireless communication module such that one or more of the components of the system 100 may be collocated or separately located relative to one another.

In general, the navigation module 104 provides navigation information to the control module 102, including the current geographical location of the vehicle. In one embodiment, the navigation module 104 is realized as a global positioning system (GPS) component that derives the current position from real-time GPS data received from GPS satellites. In other embodiments, the navigation module 104 may be omitted and the current location may be provided by the user for use by the control module 102. In other embodiments, the current location may be determined from non-GPS sources, such as sensor data, or provided from another system.

In some embodiments, the navigation module 104 may additionally provide route information to the user based on a starting or current location to a destination, as well as intervening waypoints. As an example, the user may input a starting location and a destination to the system 100 via the graphical user interface 110, and the navigation module 104 determines and displays the appropriate route for the user. As another example, the user may provide a destination to the system 100 via the graphical user interface 110, and the navigation module 104 determines and displays the most appropriate route between the current location and the destination. As discussed below, the route provided by the navigation module 104 may generally include a map of the route, a description of sections that make up the route (e.g., road or highway segments, intersections, on/off ramps, city blocks, geographic regions, etc.), and driving directions.

As described below, the navigation module 104 may also interact with the control module 102 to determine the geographical location of the vehicle at the end of an interval, as well as navigation and mapping information about the geographical location associated with the interval. Additional information about the interval is provided below, but generally, the interval corresponds to a user-defined distance or time duration from a current location or future location. Accordingly, the navigation module 104 may store or otherwise have access to traffic and/or road condition data such that a location of the vehicle at the conclusion of the interval may be determined, as well as an estimated time of arrival, as discussed in greater detail below.

The point of interest data source 106 generally contains stored and/or real-time data associated with points of interest at or near geographical locations. The point of interest data source 106 may be embodied as locally stored, cached, downloaded, or remotely accessible point of interest data that can be processed by the control module 102. For example, the point of interest data source 106 may be realized as one or more hard disks, semiconductor memory devices, portable storage media, or other types of memory that is accessible by the control module 102, either on the vehicle or at a data center. As discussed in greater detail below, the point of interest data may include information about hotels, restaurants, gas stations, historical sites, and any other types of data that may be of interest to the user. Any number and combination of types of point of interest data, including more or less than those discussed herein, may be processed by the control module 102. In a practical embodiment, the point of interest data may be obtained, accessed, or derived from various public or private sources.

Briefly, the audio device 108 may receive audio signals from the control module 102, for example, that convey navigation instructions, user prompts, warning signals, and other audible signals. The audio device 108 may further function as an input device to receive audio commands from the user and provide the commands to the control module 102. As described below, the audio device 108 may be integrated with the graphical user interface 110.

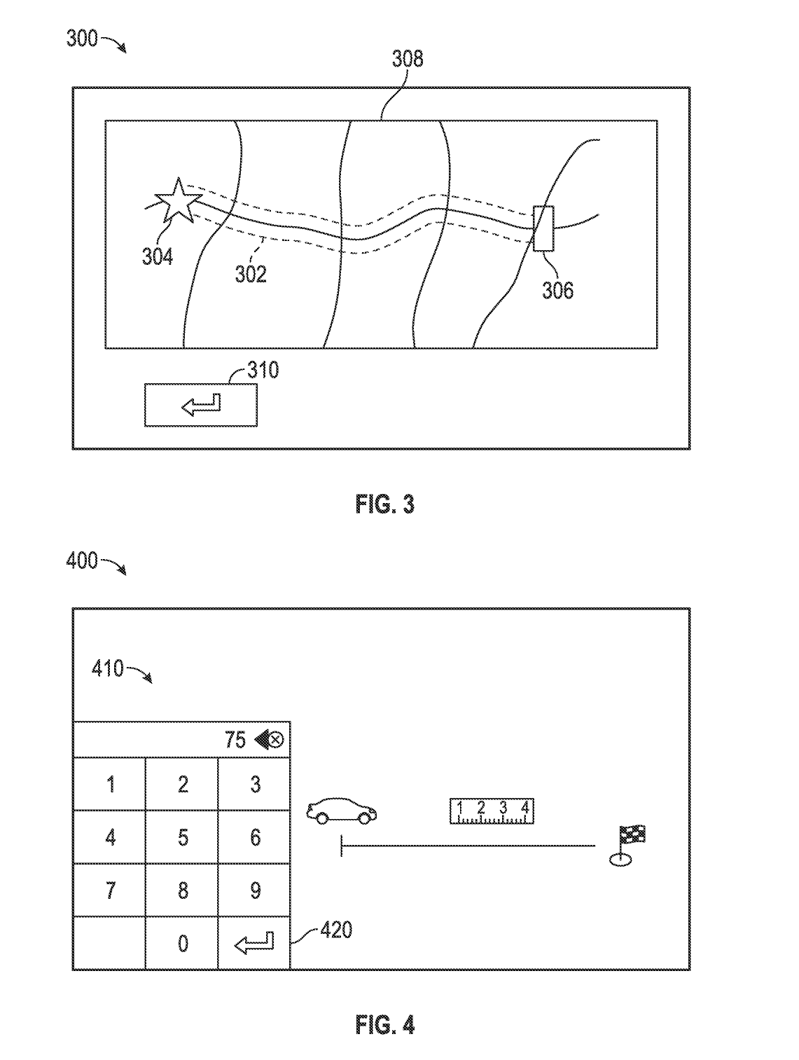

In general, the graphical user interface 110 may be configured to enable any type of interaction between the user and the system 100. As noted above, the graphical user interface 110 includes a display device 112, such as a suitably configured liquid crystal display (LCD), plasma, cathode ray tube (CRT), or head-up display. Accordingly, the control module 102 may provide rendering control signals to the display device 112 to render maps, proposed routes, roads, navigation direction arrows, point of interest information, and other graphical elements, including the elements discussed below with reference to FIGS. 3-10.

The graphical user interface 110 additionally functions as a user input device 114 configured to allow the user to enter data and/or control the functions and features of the system 100. For example, the user input device 114 may be formed by interactive graphical elements rendered on a touch screen of the display device 112. In some embodiments, the user input device 114 may have additional modes to enter user data and/or interact with the graphical elements, including a keyboard or keypad, a voice recognition system, a cursor control device, a joystick or knob, or the like. In particular, and as described below, the user input device 114 enables a user to request desired point of interest information associated with an interval along a route.

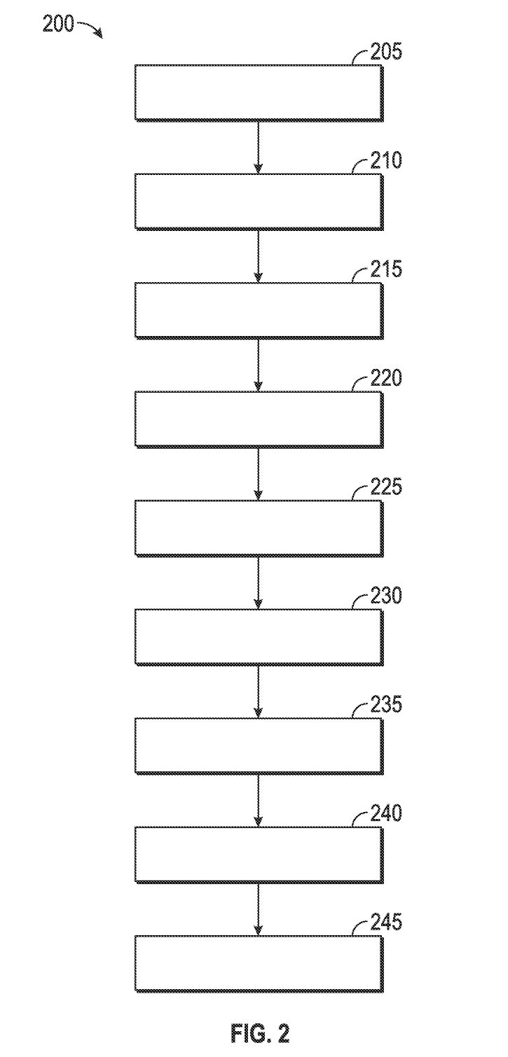

Now that the basic structure of the system 100 has been described, an exemplary description of the function will be provided as a method 200, which is depicted as a flowchart in FIG. 2. Since the method 200 may be implemented with the system 100, both FIGS. 1 and 2 are referenced below. The method 200 and system 100 will also be described with reference to FIGS. 3-10, which are exemplary representations of information provided to the user on, for example, the graphical user interface 110 of the system 100.

In general, the system 100 and method 200 provide point of interest information in a vehicle along a route to a destination. As such, the system 100 may include or be associated with a navigation or mapping system (e.g., navigation module 104) that generates driving directions based on a predetermined starting point (or the current location) and a destination. Accordingly, generally, at the outset of the method 200, the user has a predetermined route to the destination. As an example, FIG. 3 depicts an exemplary representation of such a route 302 provided on a display such as the display device 112 of graphical user interface 110. As shown in FIG. 3, the user is traveling a route 302 between a current location (or a selected location) 304 and a destination 306, which may be depicted in a map view 308. The map view 308 is a visual representation of the actual area through which the route 302 passes and may include driving instructions associated with the route 302.

In an exemplary embodiment, the system 100 and method 200 may be utilized when a user has a general anticipation or desire for point of interest information at an uncertain future location, e.g., not at the current location, destination, or particular known location. Instead, the user desires point of interest information at the conclusion of a selected interval. The interval may be defined as a selected distance or time duration from a current location or a future location. For example, if it is approximately 10:00 A.M. and the user wants to plan lunch, the user may request restaurant information for a presently unknown location about two hours away from the current location (e.g., at about 12:00 P.M.). Or, if the user is trying to plan lodging but wants to drive an additional 75 miles before stopping, the user may request hotel information about 75 miles from the current location. As described in greater detail below, the system 100 and method 200 provide the point of interest information associated with these user-defined intervals. Reference below is made to FIGS. 1-3, as well as FIGS. 4-9 specifically introduced below.

The graphical user interface 110 may include an activation input button (or other activation mechanism) 310 to activate the method 200 described below. As such, in a first step 205 of the method 200, the control module 102 receives an activation signal from the user, e.g., in the form of the input button 310 in FIG. 3 or other input mechanisms via the user input device 114.

In a second step 210, the control module 102 may generate and display an interval input display on the graphical user interface 110, and in step 215, the control module 102 receives the interval from the user via the graphical user interface 110. As noted above and discussed in greater detail below, the interval may be defined in a number of ways.

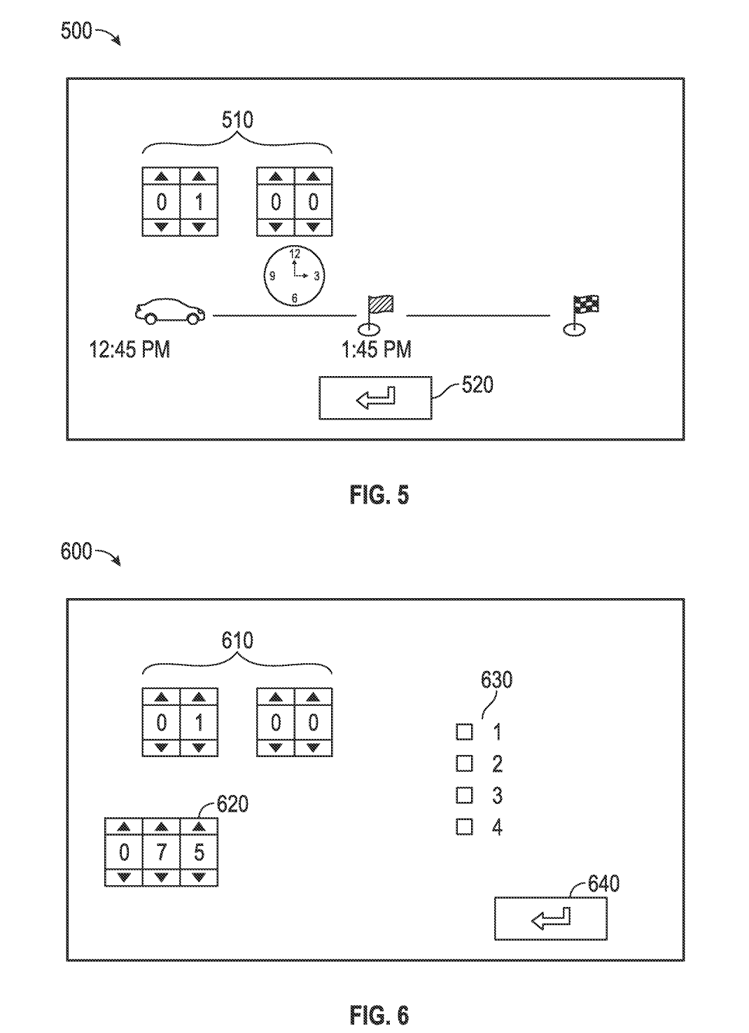

Referring to steps 210 and 215, as one example, FIG. 4 is an exemplary representation of an interval input display 400. In the exemplary embodiment of FIG. 4, the interval is expressed as a number of miles from a current location, e.g., 75 miles from the current location in the depicted example. As such, the interval input display 400 has an input field 410 to accept a user input corresponding to the number of miles at which the user desires point of interest information. Upon entry of the mileage interval in the input field 410, selection of the calculate or next button 420 results in calculation of the interval. Other ways of defining the interval are described below with reference to FIGS. 5 and 6.

FIG. 5 is an exemplary representation of an interval input display 500 in accordance with an alternate embodiment. In the exemplary embodiment of FIG. 5, the interval is expressed as a time duration such that the user is requesting point of interest information for a location at a predetermined time duration from a current location. As such, the interval input display 500 has an input field 510 to accept a user input corresponding to the time duration, e.g., one hour in the current location in the depicted example. Although not shown, the time duration input field 510 may also be expressed as a clock time (e.g., 10:00 P.M.) such that the time duration may be defined as the difference between a current time and the entered time. Upon entry of the time interval in the input field 510, selection of the calculate or next button 520 results in calculation of the interval.

FIG. 6 is an exemplary representation of an interval input display 600 in accordance with an alternate embodiment. In the exemplary embodiment of FIG. 6, the interval may be expressed as a time duration or a distance from an intermediate or future location along the route. As such, the interval input display 600 has a time duration input field 610 to accept a user input corresponding to the time duration and a distance input field 620 to accept a user input corresponding to the distance. The interval input display 600 may be configured to accept either the time duration input field 610 or the distance input field 620. In some embodiments, one of the fields 610, 620 may be omitted. The interval input display 600 may further include a future location field 630 from which the interval should be calculated. The future location is typically a location between the current location and the destination and may be considered an intermediate waypoint. As shown, the future location field 630 may be presented as a list of cities or towns along the route that are selectable by the user. In other embodiments, the future location field 630 may receive a typed name of the future location or may display a route map from which the user may manually indicate the future location.

As such, the interval input display 600 enables the calculation of the interval and determination of point of interest information at locations other than the current location, e.g. at an interval from a selected destination or other type of waypoint along the route. Upon entry of the interval in one of the fields 610, 620 and selection of the intermediate waypoint, a calculate or next button 640 may be selected.

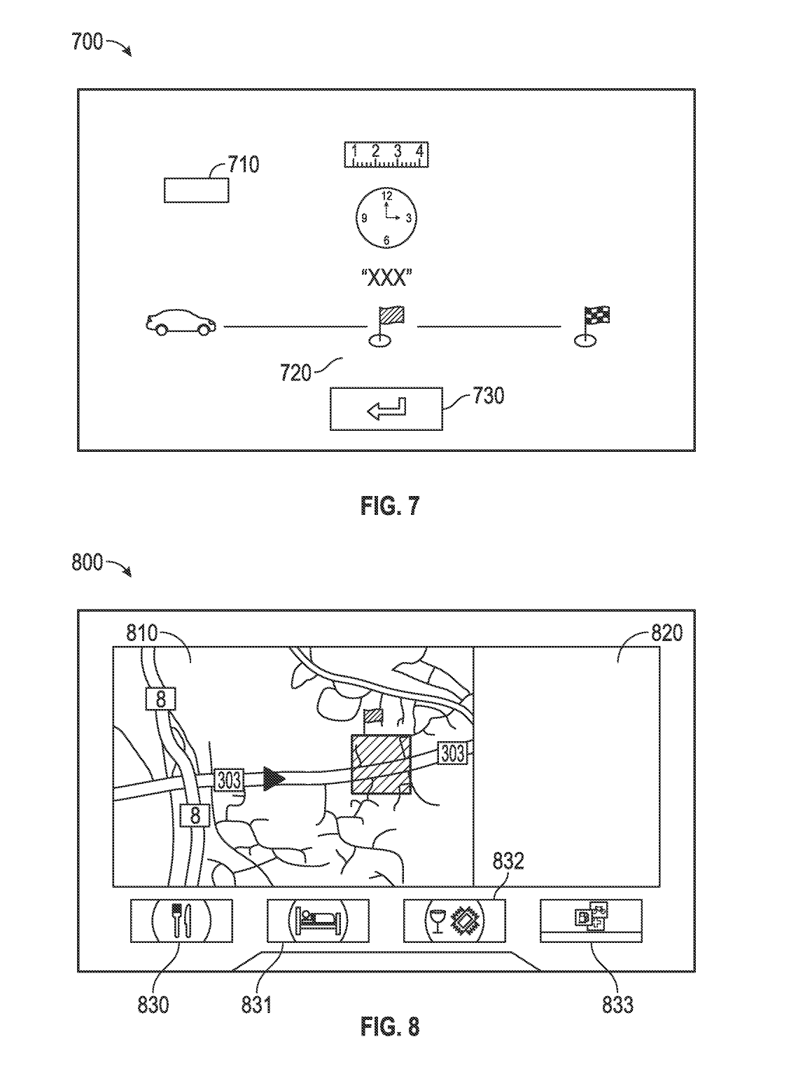

Returning to FIG. 2, in step 220, the control module 102 calculates the characteristics associated with the interval and presents the characteristics to the user. As such, the control module 102 executes control logic to calculate a location and time of arrival based on the user-defined interval, as well as the identity of the resulting interval location. As an example, reference is made to FIG. 7, which is an interval characteristics display 700 that may be presented on the graphical user interface 110. As shown in FIG. 7, the interval characteristics display 700 may provide a location associated with the conclusion of the interval (e.g., an interval location or interval waypoint, terms which are used interchangeably below). The interval characteristics display 700 may further provide an indication of the distance (e.g., 75 miles) in the interval and/or the time 720 (e.g., 1:45 P.M.) at which the user will arrive at the interval waypoint.

As noted above in reference to FIGS. 4-6, the user may input the interval in a number of forms. In effect, the interval characteristics display 700 correlates these forms relative to one another and identifies the interval location. For example, if the interval is expressed as a time duration (as in FIG. 4), the interval characteristics display 700 provides the number of miles to the resulting interval waypoint. As another example, if the interval is expressed as a distance (as in FIG. 5), the interval characteristics display 700 provides the approximate duration of the interval and/or time of arrival at the resulting interval waypoint. Alternatively, if the interval is expressed as a time or distance duration from an intermediate waypoint, the interval characteristics display 700 of FIG. 7 may present information about the distance or time at which the user will arrive at the waypoint, as calculated from an estimated time and distance to the intermediate waypoint and then to the interval waypoint. The interval characteristics display 700 may also include a next button 730 to provide further information about the interval, as described below.

The control module 102 may calculate the characteristics of the interval, including the location of the waypoint based on a number of factors, including speed of the vehicle, user settings, road and traffic conditions, and the like. For example, given the distance interval in the example of FIG. 4, the control module 102 determines how long it will take the vehicle to travel that number of miles based on, for example, traffic conditions and the route speed limit(s). Similarly, given the time interval in the example of FIG. 5, the control module 102 determines that the vehicle will travel a corresponding number of miles within that time period. Finally, given the interval information and future location in the example of FIG. 6, the control module 102 determines the time and distance required to travel to the future location as well as the time and distance associated with the interval beyond that future location.

In step 225, the control module 102 generates and displays a map view of the interval waypoint on the graphical user interface 110. As an example, FIG. 8 depicts a representation of such a map view 800. The map view 800 may include a map 810 of the interval waypoint and information 820 about the interval waypoint, including the name of the nearest city or town, the street or road associated with the route at the interval waypoint, and the nearest intersection of streets or roads at the interval waypoint.

In step 230, the system 100 receives a point of interest selection from the user, e.g., via the graphical user interface 110. The point of interest selection may be a particular point of interest at the interval waypoint (e.g. that may individually displayed on the map view of the interval waypoint) or a type of point of interest.

As an example, the map view 800 of FIG. 8 includes point of interest selections 830-833, which in this embodiment represent types or related groups of points of interest. Any type or number of point of interest selection 830-833 may be provided, including, but not limited to, points of interest associated with food or restaurants 830, hotels or lodging 831, entertainment 832, and a selection for all points of interest 833.

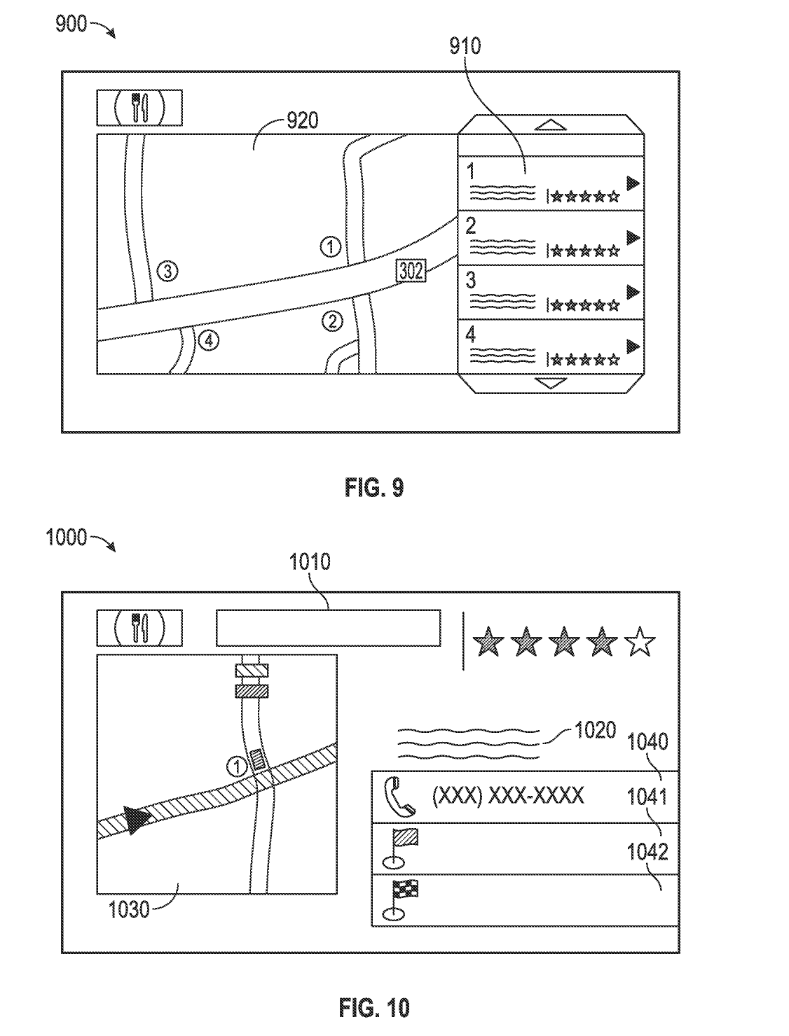

Upon selection of the desired point of interest type, the method 200 proceeds to step 235 in which the control module 102 generates and displays the selected points of interest on the graphical user interface 110. As an example, FIG. 9 is a view 900 depicting a selected group of points of interest. In this example, the selected group corresponds to restaurants (e.g., selection 830 in FIG. 8). The group view 900 includes a list 910 of the points of interest associated with the type selection, e.g., in this example, a list of restaurants at the interval waypoint. The group view 900 may further include a map 920 graphically indicating the points of interest on a map of the interval waypoint. In this embodiment, the each point of interest in list 910 may be selectable to request additional information about the point of interest.

In step 240, the control module 102 of the system 100 may receive a selected point of interest from the user via the graphical user interface 110, e.g. from the list 910 of FIG. 9.

In step 245, the control module 102 of the system 100 may generate and display information associated with the selected point of interest. As an example, FIG. 10 is a point of interest view 1000 corresponding to the selected point of interest. In one exemplary embodiment, the point of interest view 1000 may include the name of the point of interest 1010, summary information 1020 about the point of interest, a map 1030 indicating the location of the point of interest, and commands 1040-1042 associated with the selected point of interest. Generally, the summary information 1020 about the point of interest may include hours of operation, a summary of goods or services, and customer reviews. The commands 1040-1042 may include a command to call the point of interest 1040, e.g., via a vehicle communications system, a command to position the interval waypoint at the point of interest 1041, and a command to set the point of interest as the destination 1042.

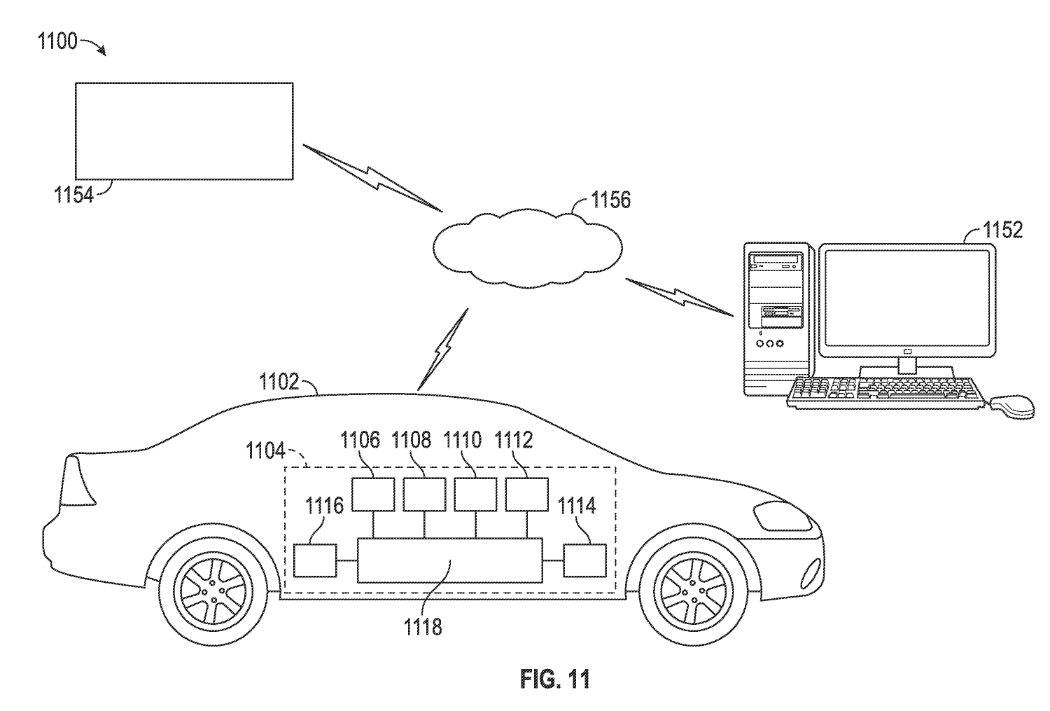

FIG. 11 is a schematic representation of an alternate exemplary embodiment of an information system 1100. Although the information system 1100 generally operates as the information system 100 discussed above, at least some components of the information system 1100 are incorporated into a vehicle 1102 and/or a general computing device 1152 that communicate with a data center 1154 via a network 1156. Although the data center 1154 is illustrated in FIG. 11 as being remote from the vehicle 1102, the data center 1154 may additionally be onboard the vehicle 1102. The vehicle 1102, computing device 1152, data center 1154, and network 1156 will initially be described, followed by a description of the operation of the information system 1100.

The vehicle 1102 may be any type of vehicle, including an automobile, a truck, a recreational vehicle, a motorcycle, an aircraft and a water craft. In one exemplary embodiment, the vehicle 1102 includes a vehicle module 1104 that includes a global positioning system (GPS) component 1106, a user interface 1108, a vehicle communication system 1110, a display device 1112, an audio device 1114, and vehicle storage 1116, each coupled to a vehicle processor 1118. The vehicle processor 1118 may be any type of computer, microprocessor or controller and perform at least some of the functions described above in reference to the control module 102 of FIG. 1. The vehicle module 1104 may be, for example, a vehicle navigation device or system.

The GPS component 1106 may generally correspond to the navigation module 104 discussed above in FIG. 1 and is capable of interacting with GPS satellites to determine the current location of vehicle 1102. In alternate embodiments, the GPS component 1106 may be omitted and the vehicle module 1104 may utilize positioning data provided by a cellular telecommunication network or any appropriate locating system, or the vehicle module 1104 may rely on the user to enter the current location or desired starting point.

The user interface 1108 may generally correspond to the user input device 114 discussed above in FIG. 1. The user interface 1108 is configured to allow the driver of the vehicle 1102 to initiate point of interest information requests via buttons, controls, or microphones. For example, the user interface 1108 may be a touchscreen with user-interface elements, such as drop down lists, check boxes, radio buttons, text input fields, or the like implemented using a variety of programming languages or programming methods.

The vehicle communication system 1110 is configured to communicate with a data center 1154. Such communications may include the transmission of vehicle data, request signals from the vehicle, and the receipt of response signals from the data center 1154. In one exemplary embodiment, the vehicle communication system 1110 includes a telematics or cellular telecommunications system. In other examples, communication devices other than cellular telecommunications may be employed. For example, and without limitation, an RF transceiver, a WiFi communications device, a satellite communications device, a dedicated short range communications device, or any other type of communications device effective to communicate with data center 1154 may be employed.

The display device 1112 generally corresponds to the display device 112 of FIG. 1 and may, for example, be any suitable display device for providing a visual display of the proposed route. The display device 1112 may, for example, display the visual components illustrated in FIGS. 3-10. The audio device 1114 generally corresponds to the audio device 108 of FIG. 1 and may, for example, be any suitable audio device for providing audible route instructions to the driver of the vehicle 1102.

The vehicle module 1104 may further include vehicle storage 1116 configured to store instructions for the vehicle processor 1118 as well as any route or vehicle data for access by the other module components. The vehicle storage 1116 may store the point of interest and mapping data described herein, although generally, such data is accessed from the data center 1154 as described below. The vehicle storage 1116 can be implemented with any type of hardware, such as a magnetic disk, an optical disk, a semiconductor memory, or any other recording medium.

The data center 1154, in general, may be any collocated or separately located databases that are accessible to the computing device 1152 and the vehicle module 1104 via the network 1156. For example, the data center 1154 may include the point of interest data source 106 and at least some of the processing function of the control module 102 discussed above in FIG. 1. As such, the data center 1154 may include any number of processors, switches, servers, databases, and live advisors, as well as a variety of other telecommunication and computer equipment. The data center 1154 may be a call center, for example.

The network 1156 may include any hardware, software, and firmware necessary to convey content between the vehicle module 1104 and the computing device 1152. Such content may be contained within analog or digital signals and conveyed through data or voice channels. The network 1156 may also include network equipment, such as routers, data lines, hubs, and intermediary servers which together form a packet-based network, such as the Internet or an intranet. The network 1156 may further include circuit-based communication components and mobile communication components, such as telephony switches, modems, cellular communication towers, and the like.

As examples, the network 1156 may include local-area networks (LAN), wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. The network 556 may include a single local area network (LAN) or wide-area network (WAN), or combinations of LANs or WANs, such as the Internet. The various devices coupled to the network 1156 may incorporate wireless connections, including short-range (e.g., inductive telemetry or Bluetooth) or longer-range (e.g., IEEE 802.11, IEEE 802.x wireless communication, 3G, 4G, or cellular wireless) protocols.

The computing device 1152 may be any general purpose computing device. For example, the computing device 1152 may be a laptop computer, desktop computer, smartphone, smart device, handheld navigation systems, or the like.

As such, during an exemplary operation, the vehicle module 1104 may generate an interval information request. For example, the user may provide the desired interval information to the vehicle processor 1118 via the user interface 1108. As noted above, the interval information may be expressed as a time or distance duration from a current or future location. The vehicle processor 1118 additionally receives the current (or starting) location from the GPS component 1106 and suitably packages the current location, the destination, and the interval information such that the communication system 1110 sends the interval information request to the data center 1154 via the network 1156. The data center 1154 receives the interval information request and generates information associated with the interval, including the location of the interval, the time of arrival at the interval, and/or the distance to the interval, and provides the interval information to the vehicle module 1104 via the network 1156. The vehicle processor 1118 receives the interval information and generates display and audio signals to convey the interval information to the user via the display device 1112 and audio device 1114. The vehicle processor 1118 additionally receives a point of interest information request associated with the interval from the user such that the communication system 1110 sends the point of interest information request to the data center 1154 via the network 1156. The data center 1154 receives the point of interest information request and generates point of interest information, including a list of points of interest and information about each point of interest associated with the interval, and provides the point of interest information to the vehicle module 1104 via the network 1156. The vehicle processor 1118 receives the point of interest information and generates display and audio signals to convey the point of interest information to the user via the display device 1112 and audio device 1114. Additionally, in some exemplary operations, the computing device 1152 may generate such requests and receive information in response to those requests from the data center 1154 via the network 1156 such that the information may be printed or saved for later navigation.

Accordingly, the exemplary systems and methods described above provide improved point of interest information based on user-defined intervals. Exemplary embodiments have been described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, exemplary embodiments may be practiced in conjunction with any number of practical vehicle navigation system platforms, architectures, and deployments.

While at least one exemplary example has been presented in the foregoing detailed description, it should be appreciated that a vast number of variations exist. It should also be appreciated that the exemplary example or exemplary examples are only examples, and are not intended to limit the scope, applicability, or configuration in any way. Rather, the foregoing detailed description will provide those skilled in the art with a convenient road map for implementing the exemplary example or exemplary examples. It should be understood that various changes can be made in the function and arrangement of elements without departing from the scope as set forth in the appended claims and the legal equivalents thereof.

What is claimed is:

1. A method for providing point of interest information in a vehicle along a route to a destination, the method comprising the steps of:
receiving, from a user, an interval between a current location and the destination;
determining an interval location based on the interval;
generating point of interest information associated with the interval location; and
displaying the point of interest information on a display device.

2. The method of claim 1, wherein the displaying step includes displaying a map of the interval location with the point of interest information.

3. The method of claim 1, wherein the displaying step includes displaying an estimated time of arrival at the interval location.

4. The method of claim 1, wherein the determining step includes determining the interval location based on the interval from the current location.

5. The method of claim 4, wherein the receiving step includes receiving the interval defined by a selected distance such that the interval location is the selected distance from the current location.

6. The method of claim 4, wherein the receiving step includes receiving the interval defined by a selected time duration such that the interval location is the selected time duration away from the current location

7. The method of claim 1, further comprising the step of:
receiving, from the user, an intermediate waypoint between the current location and the destination, and wherein the determining step includes determining the interval location from the intermediate waypoint.

8. The method of claim 1, further comprising the step of establishing the interval location as an interval waypoint and displaying navigation information from the current location to the interval waypoint.

9. The method of claim 1, wherein the displaying step include displaying the point of interest information as a list of point of interest items associated with the interval location.

10. The method of claim 1, wherein the displaying step includes displaying the point of interest information for a group of points of interest associated with the interval location, and wherein the method further comprises receiving, from the user, a selection of one of the group of points of interest, and wherein the displaying step includes displaying the point of interest information for the selected one of the group of points of interest.

11. The method of claim 9, further comprising receiving, from the user, the destination from the user and displaying navigation information assocateid with a route between the current location and the destination on the display device.

12. A system for providing point of interest information in a vehicle along a route to a destination, comprising:
a point of interest data source storing point of interest information for a plurality of points of interest;
a control module coupled to the point of interest data source and configured to
receive, from a user, an interval between a current location and the destination;
determine an interval location based on the interval; and
retrieve point of interest information associated with the interval location from the point of interest data source; and
a display device coupled to the control module and configured to display the point of interest information associated with the interval location.

13. The system of claim 12, wherein the display device is configured to display a map of the interval location with the point of interest information.

14. The system of claim 12, wherein the display device is configured to determine the interval location based on the interval from the current location.

15. The system of claim 14, wherein the control module is configured to receive the interval defined by a selected distance and to determine the interval location as the selected distance from the current location.

16. The system of claim 14, wherein the control module is configured to receive the interval defined by a selected time duration and to determine the interval location as the selected time duration away from the current location

17. The system of claim 12, wherein the control module is configured to receive, from the user, an intermediate waypoint between the current location and the destination.

18. The system of claim 17, wherein the control module is configured to determine the interval location from the intermediate waypoint.

19. The system of claim 12, wherein the display device is configured to display the point of interest information for a list of points of interest items associated with the interval location.

20. A system for providing point of interest information in a vehicle along a route to a destination, comprising:
a navigation module configured to determine a current location of the vehicle;
a user interface coupled to the navigation module and configured to receive, from a user, an interval between the current location and the destination;
a vehicle module coupled to the navigation module and the user interface and configured to
receive the interval from the user interface;
determine an interval location based on the interval; and
retrieve point of interest information associated with the interval location; and
a display device coupled to the vehicle module and configured to display the point of interest information associated with the interval location.
